(19) United States
(12) Patent Application Publication
(10) Pub. No.: US 2026/0237804 A1
(43) Pub. Date: Aug. 13, 2026

(54) SEMI-FINISHED PART FOR FORMING A HOUSING ELEMENT OF A CELL UNIT

(71) Applicant: Carl Freudenberg KG, Weinheim (DE)

(72) Inventor: Wilhelm SCHMIDT, Heppenheim (DE)

(21) Appl. No.: 19/537,776

(22) Filed: Feb. 12, 2026

(30) Foreign Application Priority Data
Feb. 12, 2025 (DE) 10 2025 105 104.6

(51) Int. Cl. H01M 50/169; H01M 50/103; H01M 50/119

(52) U.S. Cl. CPC H01M 50/169; H01M 50/103; H01M 50/119

(57) ABSTRACT

A semi-finished part for forming a housing element of a cell unit includes a base element having a first side opposite a second side, a first side element, a second side element, and a third side element. The first side element is disposed contiguously with the base element at the first side. The second side element is disposed contiguously with the base element at the second side, and the third side element is disposed contiguously with the second side element at a side opposite the base element. The base element, the first side element, the second side element, and the third side element are disposed in a plane. The base element, the first side element, the second side element, and the third side element are adapted to form a circumferentially closed, fluid-tight main body in which a cell element of the cell unit can be disposed.

### CROSS REFERENCE TO RELATED APPLICATIONS

This application claims benefit to German Patent Application No. DE 10 2025 105 104.6, filed on February 12, 2025, which is hereby incorporated by reference herein.

### FIELD

The present invention relates to a semi-finished part for forming a housing element of a cell unit of an electrical energy storage device, a method for forming a housing element, a method for forming a semi-finished part, a housing element, as well as a vehicle, and/or a stationary storage device.

### BACKGROUND

There are currently a wide variety of different approaches for forming housing elements in cell technology. Due to the increasing number of cell units in vehicles and in stationary applications, as well as higher performance and quality requirements, the demand for innovative and robust cell systems is continuously growing.

The continuously increasing efficiency in automotive technology to reduce consumption, as well as the increasing competition, are creating cost pressure, resulting in a strong demand for cheaper and more efficient components for vehicles.

### SUMMARY

In an embodiment, the present disclosure provides a semi-finished part for forming a housing element of a cell unit that includes a base element having a first side opposite a second side, a first side element, a second side element, and a third side element. The first side element is disposed contiguously with the base element at the first side. The second side element is disposed contiguously with the base element at the second side, and the third side element is disposed contiguously with the second side element at a side opposite the base element. The base element, the first side element, the second side element, and the third side element are disposed in a plane. The base element, the first side element, the second side element, and the third side element are adapted to form a circumferentially closed, fluid-tight main body in which a cell element of the cell unit can be disposed.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a semi-finished part according to a first embodiment;

FIG. 2 shows a housing element of the embodiment of FIG. 1;

FIG. 3 shows a semi-finished part according to a second embodiment;

FIG. 4 shows a semi-finished part according to a third embodiment;

FIG. 5 shows a housing element according to the third embodiment;

FIG. 6 shows a flowchart illustrating steps of the method for forming a semi-finished part according to an embodiment;

FIG. 7 shows a semi-finished part according to the third embodiment;

FIGS. 8 and 9 show flowcharts illustrating steps of the method for forming a housing element according to an embodiment;

FIG. 10 shows a vehicle; and

FIG. 11 shows a stationary storage device.

### DETAILED DESCRIPTION

The present disclosure provides a semi-finished part for forming a housing element of a cell unit of an electrical energy storage device, as well as a method for producing a housing element of a cell unit, which is simple and less expensive to manufacture and also easier to transport.

Embodiments of the present disclosure can advantageously provide an improved semi-finished part for forming a housing element of a cell unit.

One advantage of the semi-finished part for forming a housing element of a cell unit as included in the present disclosure is that it significantly simplifies the transport of the housing element and enables new, additional supply chains. In particular, the semi-finished part can be configured specifically for the respective cell unit, with the semi-finished part being flat in a plane. Unlike pre-assembled housing elements, it can be easily transported worldwide because of its flat configuration. The joining of the semi-finished part to form the housing element may preferably take place in the device in which a cell element (e.g., a membrane, bipolar plates, insulators, etc.) is incorporated into the housing element. Further preferably, by adapting the dimensions of the semi-finished part, it can be more easily adapted to new cell sizes as well as new cell concepts. This makes it possible, in particular, to significantly reduce or eliminate the cost of making tools for providing housing elements.

In an embodiment of the present disclosure, the semi-finished part for forming a housing element of a cell unit includes a base element, a first side element, a second side element, and a third side element. The first side element and the second side element are disposed on opposite sides of the base element and contiguous therewith. The third side element is disposed on a side of the second side element opposite the base element and contiguous with the second side element. The first, second, and third side elements, as well as the base element, are disposed in one plane. The base element, the first, second, and third side elements are adapted to form a circumferentially closed, fluid-tight main body of the housing element. A cell element of the cell unit can be disposed in the main body.

The four surface elements, namely the base element and the three side elements, thus form a semi-finished part from which a hollow-bodied housing element having two opposite openings can be produced, for example, at a customer's site. At the customer's site, the two openings are then mounted with a base element on one side and a cover element on the other side to form a closed housing. The cell elements are preferably inserted prior to closing the housing with the cover element. After closing with the cover element, the cell unit is filled with an electrolyte through a filling opening, which may be provided in one of the walls, preferably in the cover element.

It should be noted that the cell element may preferably also be placed and oriented, for example, on the base element prior, to joining the semi-finished part, whereupon the hollow body is produced around the cell element by plastic deformation processes. Subsequently, the base element and the cover element are attached to the hollow body. Further alternatively, it is also possible to first form the hollow body by plastic deformation, then attach the bottom element, and subsequently insert the cell element into the hollow body, which is thus open on one side, and in a final step, dispose the cover on the only remaining opening.

It should be noted that, after the plastic deformation, the hollow body can be produced, for example, by welding along a contact seam between the first and the third side elements, and the bottom element and/or the cover element can also be fixed to the hollow body by means of welds.

In other words, the semi-finished part can be cut from a sheet-metal blank or something similar so as to include the base element, the first side element, the second side element, and the third side element, so that these elements are in one plane as a single piece and/or a single part. Preferably, the first side element, the second side element, and the third side element can be arranged relative to the base element in such a way that a fluid-tight space can be created in which, preferably, a cell element of a cell unit, such as an electrode stack or the like, can be disposed.

Further preferably, the semi-finished part includes a bottom element contiguous with the base element. The base element, the first, second, third side elements, and the bottom element are adapted to form a fluid-tight space in which the cell element of the cell unit can be disposed. The bottom element is directly contiguous with the base element. Thus, the bottom element, the first side element, and the second side element are directly contiguous with the base element, and the third side element is contiguous with the second side element. This allows a hollow body having a bottom element to be produced by plastic deformation and fixing the surface elements at the joints. The cell element is then inserted into the hollow body, or the cell element is placed on the base element prior to the plastic deformation, and the other surface elements are subsequently deformed around the placed cell element so as to produce the fluid-tight hollow body which is open on one side. Then, in a final step, a separate cover element is attached and an electrolyte is filled in.

Further preferably, the semi-finished part further includes a cover element that is disposed opposite the bottom element and contiguous with the base element. Thus, four surface elements, namely the cover element, the bottom element, and the first and second side elements are contiguous with the base element. In total, the semi-finished part thus includes six surface elements, which can then be deformed so as to form a fluid-tight, cuboidal hollow body as a housing for a cell unit, and the contacting edges can be joined together.

Preferably, a bending line is provided between each of adjacent ones of the surface elements. The bending line is provided, in particular, between the base element and the first side element, and/or between the base element and the second side element, and/or between the second side element and the third side element, and/or between the base element and the bottom element, and/or between the base element and the cover element. The bending line is preferably a score line and is formed into the flat semi-finished part prior to the plastic deformation during the manufacture of the semi-finished part.

One advantage of this embodiment is that it significantly simplifies the joining of the respective components of the semi-finished part and makes it possible, in particular, to improve positional tolerances.

Preferably, a contacting element is disposed in one of the surface elements, in particular in the first side element, in the second side element, in the third side element, and/or in the base element, and/or in the cover element, the contacting element being adapted to conduct electrical energy from an inside of the substantially fluid-tight space to an outside of the housing element.

One advantage of this embodiment is that the contacting element can already be incorporated into the semi-finished part in the plane, as this is much easier than when then housing element is in an assembled state.

Further preferably, the base element, the first side element, the second side element, the third side element, the bottom element, and/or the cover element have a rupture element adapted to enable a fluid to flow out of the substantially fluid-tight space when a predetermined temperature and/or a predetermined pressure in the housing element are exceeded.

One advantage of this embodiment is that the probability of the rupture element being damaged during assembly in a plane is significantly reduced, since the element is much easier to install in the plane than when then housing element is in an assembled state.

The surface elements, i.e., the first side element and/or the second side element and/or the third side element and/or the base element and/or the bottom element and/or the cover element preferably have a rectangular shape, so that the manufactured housing element then has a cuboid shape.

A further aspect of the invention relates to a method for forming a housing element using a semi-finished part, as described above and below, including the steps of:

providing the semi-finished part, including a base element, a first side element, a second side element, and a third side element,

orienting the first side element, the second side element, and the third side element relative to the base element,

joining the first side element to the third side element so as to form a hollow cuboid having two opposite openings.

One advantage of this embodiment is that the configuration of the semi-finished part, as well as the process steps, allow the housing element to be specifically adapted to different cell units and/or cell elements. The orienting operation may preferably be a bending or similar operation. Further, the joining operation may be in particular a welding or similar operation.

Further preferably, a bottom element and/or a cover element, which are separate components, are then adjoined to the hollow cuboid which is open on both sides.

Further preferably, the semi-finished part further includes a bottom element contiguous with the base element. Thus, by plastic deformation and joining of this semi-finished part, a hollow cuboid can be formed that is open on one side only. The open side can then be closed by a separate cover element.

In accordance with another embodiment of the invention, the semi-finished part further includes a cover element. The cover element is also contiguous with the base element. Thus, the first and second side elements, the bottom element, and the cover element are each disposed on a respective side of the base element and contiguous therewith. This allows the housing element to be produced entirely without a separate, additional element, i.e., a separate bottom element and/or a separate cover element.

The cell elements, as internal components of the cell unit, can be inserted into the housing element in different ways. Preferably, the cell element is inserted into the deformed and joined hollow cuboid prior to fixing the bottom element and/or the cover element in place. In an embodiment, the surface elements of the semi-finished product are deformed and joined to form the hollow cuboid, i.e., the housing element.

If the semi-finished part provides a hollow body which is open on two sides, it is preferable to first insert the cell element into the hollow body and then fix the bottom element and the cover element to the hollow body. Alternatively, it is possible to first fix the bottom element to the hollow body and only then insert the cell element into the hollow body which is open on one side. Then, in a final step, the joining of the cover element is performed. Alternatively, the cell element can also be placed on the flat blank and oriented, and the hollow body can then be joined around the cell element. Then, in a final step, the bottom element and the cover element are adjoined.

Further preferably, the method includes the steps of:

filling the fluid-tight space with an electrolyte through an opening in the cuboidal housing element,

sealing the filled substantially fluid-tight space by means of a pin and/or a material-to-material bond.

One advantage of this embodiment is that it allows the housing element to be filled despite a closed cover element, thereby improving production.

Further preferably, the method further includes the steps of:

cleaning and/or deburring the semi-finished part prior to orienting the first side element, the second side element, the third side element, and/or the bottom element relative to the base element, and/or

cleaning and/or deburring the semi-finished part subsequent to joining the surface elements to form the housing element.

One advantage of this embodiment is that the housing element is substantially free of contaminants and the like, thereby avoiding possible short circuits through the electrolyte, or the like.

Another aspect of the invention relates to a method for forming a semi-finished part, as described above and below, including the steps of:

providing a blank

forming the semi-finished part from the blank, in particular by punching, water-jet cutting, or laser cutting, the semi-finished part including a base element, a first side element, a second side element, a third side element, and in particular a bottom element, and/or in particular a cover element, which are disposed in one plane and adapted to at least partially form a housing element.

An advantage of this embodiment is that the geometries of the semi-finished part can be very easily adapted from the blank, thus enabling a better response to new cell concepts or the like.

A further aspect of the invention relates to a housing element for a cell unit, which includes a semi-finished part, as described above and below, and/or which was formed using the method, as described above and below, and/or which includes a component that was formed using the method for forming a semi-finished part.

Another aspect of the invention relates to a vehicle and/or a stationary storage device including a semi-finished part, as described above and below, a housing element, as described above and below, and/or which was produced using the method for forming a housing element, as described above and below, and/or a component that was produced using the method for forming a semi-finished part, as described above and below.

All disclosures described above and below with respect to one aspect of the invention apply equally to all other aspects of the invention.

The figures are merely schematic and are not true-to-scale. In the figures, identical, identically acting, or similar elements are designated using the same reference numerals.

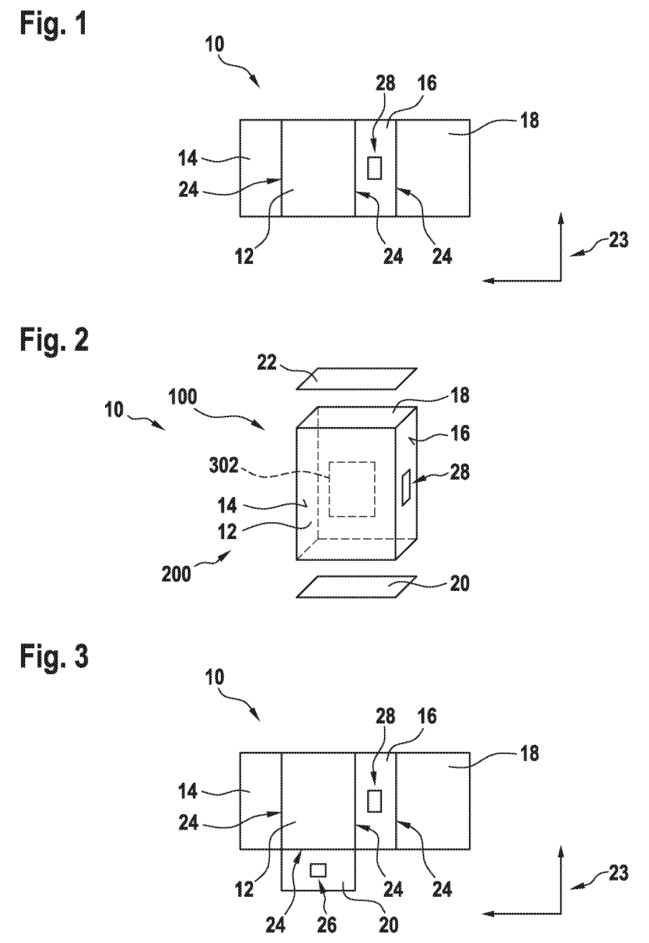

FIGS. 1 and 2 show a semi-finished part 10 for forming a housing element 100 of a cell unit 200 according to a first embodiment.

Semi-finished part 10 includes four surface elements having a rectangular shape, namely a base element 12, a first side element 14, a second side element 16, and a third side element 18. First side element 14 and second side element 16 are disposed on two opposite sides, in particular long sides, of base element 12 and contiguous therewith. Third side element 18 is disposed on a side of second side element 16 opposite the base element 12.

A rupture element 28 is schematically shown in second side element 16.

Semi-finished part 10 is formed lying in a plane 23, for example, from a sheet-metal material. As can be seen from FIG. 2, a housing element 100 having two open sides can be formed from semi-finished part 10. Thus, housing element 100 is a cuboid having two open sides.

The two open sides can be closed by a bottom element 20 and a cover element 22, which are separate components.

Thus, the housing element 100 of the first embodiment includes a total of six surface elements, with bottom element 20 and cover element 22 being separate elements. The other four elements, namely the base element, the first, second, and third side elements are provided as a contiguous semi-finished part 10 and are then plastically deformed and joined to form the hollow cuboid with two opposite openings.

In the final assembled state, housing element 100 then forms a fluid-tight space in which a cell element 302 (e.g., a stack) can be disposed.

In order to facilitate the deformation processes, bending lines 24 are stamped into semi-finished part 10 between intersecting surface elements. Bending lines 24 may also be produced using other methods, such as by material removal. This can prevent the material from bulging, especially during the deformation process.

The method for producing housing element 100 and cell unit 200 according to the first embodiment is such that the flat, semi-finished part 10 lying in a plane is produced from a blank. At the same time or subsequently, bending lines 24 and optionally other desired openings for filling and/or for receiving electrical terminals and/or for receiving rupture elements may then be incorporated. In a next step, housing element 100 is then produced by deformation along bending lines 24. In a joining step, the two free edges on the long sides of first side element 14 and third side element 18 are then joined together. As indicated in FIG. 2, this results in the cuboidal housing element 100 with two opposite open sides. The two open sides can then be closed by separate, flat elements, namely bottom element 20 and cover element 22.

Before doing so, a cell element 302 (e.g., a stack) must be inserted into the receiving space of housing element 100. This can be done in two ways. After producing the cuboidal housing element which is open on both sides, cell element 302 can be simply inserted into the housing element, and base element 20 and cover element 22 can then be fixed in place.

Alternatively, bottom element 20 may already be fixed in place before the cell element is inserted, and the cell element can then be inserted through the remaining open area of housing element 100. It is only then that housing element 100 is closed by cover element 22.

Further alternatively, cell element 302 may be disposed on the flat semi-finished part 10, for example, on base surface 12, and semi-finished part 10 may then be deformed and joined to form the cuboidal housing element 100 which is open on two sides. In this case, care must be taken to ensure that the cell element disposed inside is not damaged during the joining operation, for example, a welding operation. Subsequently, bottom element 20 and cover element 22 are fixed in place.

In all alternatives, in a final step, the fluid-tightly sealed housing element 110 is then filled with an electrolyte through a filling opening.

Thus, a housing element capable of being folded from a flat semi-finished part can be produced, which can, in particular, be transported to a desired location and thus takes up significantly less transport space compared to pre-manufactured housing elements.

FIG. 3 shows a semi-finished part 10 according to a second embodiment of the invention. The second embodiment corresponds substantially to the first embodiment, with the addition that base element 12 further has a bottom element 20 disposed on a free side thereof and contiguous therewith. All surface elements of the semi-finished part 10 of FIG. 3 are disposed in a plane 23. Bottom element 20 is additionally provided with a contacting element 26, such as a terminal, or at least an opening for a terminal. Thus, bottom element 20 is also integrated on the semi-finished part. This makes it possible, in particular, to produce a housing element 100 that already has a closed bottom. The housing element then only has one opening, on which cover element 22 is later fixed in place. In accordance with the previously described method, a cell element 302 can either be inserted into the deformed and joined housing element 100 or placed on base element 12 in advance, and the plastic deformation and joining can then be performed around cell element 302.

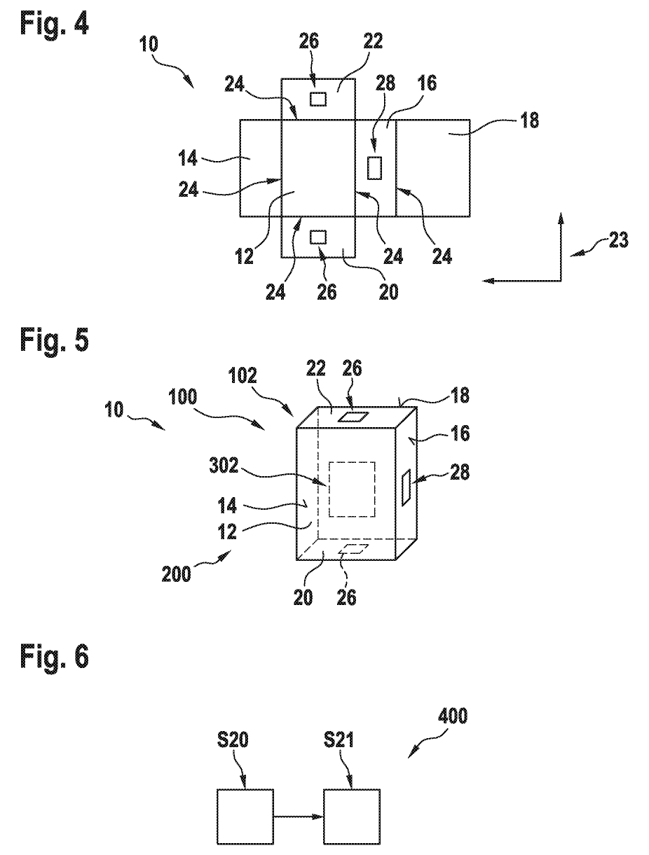

FIG. 4 shows a semi-finished part 10 for forming a housing element 100 of a cell unit 200 according to a third embodiment. Semi-finished part 10 includes a base element 12, a first side element 14, a second side element 16, a third side element 18, and a bottom element 20, and a cover element 22. Further, first side element 14, second side element 16, cover element 22, and bottom element 20 are contiguous with base element 12 and, together with base element 12, are adapted to form a fluid-tight space in which a cell element 302 can be disposed. Base element 12, first side element 14, second side element 16, third side element 18, bottom element 20, and cover element 22 are disposed in a plane 23.

Preferably, base element 12, first side element 14, second side element 16, third side element 18, bottom element 20, and/or cover element 22 may each have a contacting element 26 and/or a rupture element 28 provided therein. Preferably, rupture element 28 may be adapted to enable a fluid to flow out of the substantially fluid-tight space when a predetermined temperature and/or a predetermined pressure in housing element 100 are exceeded. Preferably, a bending line 24 may be provided at all junctions of semi-finished part 10. For example, a bending line 24 may be provided between base element 12 and first side element 14, between base element 12 and second side element 16, between base element 12 and bottom element 20, between base element 12, and cover element 22, and/or between second side element 16 and third side element 18.

FIG. 5 shows a cell unit 200 according to the third embodiment. Cell unit 200 preferably includes a housing element 100. Housing element 100 may be formed, in particular, using a semi-finished part 10, as described above and below, a cell element 302 being disposed within housing element 100. Preferably, a contacting element 26 may be disposed in cover element 22 and in bottom element 20, the contacting element being adapted to conduct electrical energy (e.g., from cell element 302) from an inside of the substantially fluid-tight space of housing element 100 to an outside of housing element 100.

FIG. 6 shows a flowchart illustrating steps of the method 400 for forming a semi-finished part 100, as described above and below. Method 400 includes the steps of:

providing S20 a blank,

forming S21 semi-finished part 10 from the blank, in particular by laser cutting or punching, the semi-finished part 10 including a base element 12, a first side element 14, a second side element 16, a third side element 18, a bottom element 20, and a cover element 22, which are disposed in a plane 23 and adapted to at least partially form a housing element 100.

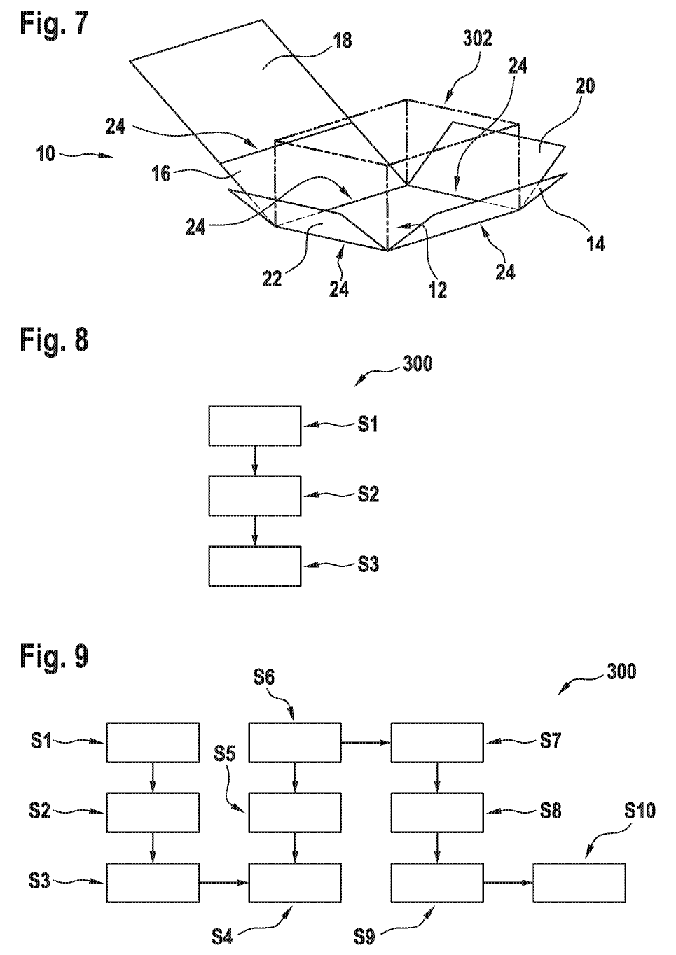

FIG. 7 shows a semi-finished part 10 according to an embodiment. Semi-finished part 10 preferably includes a base plate 12, which is largest in terms of surface area. A cell element 302 may be disposed on base plate 12. Arranged around base plate 12 are, in particular, a first side element 14, a second side element 16, a cover element 22, as well as a bottom element 20. When deformed, these elements may in particular contact cell element 302. Second side element 16 preferably has formed contiguous therewith the third side element 18 as a cover, which can close housing element 100 when cell element 302 is disposed therein.

FIG. 8 shows a flowchart illustrating steps of the method 300 for forming a housing element 100 using a semi-finished part 100, as described above and below, according to an embodiment. Method 300 includes the steps of:

providing S1 a semi-finished part 10 including a base element 12, a first side element 14, a second side element 16, a third side element 18, a bottom element 20, and a cover element 22,

orienting S2 first side element 14, second side element, 16, third side element relative, and bottom element 20 relative to base element 12,

joining S3 first side element 14, second side element 16, and third side element 18, as well as bottom element 20, first side element 14, second side element 16, and third side element 18.

FIG. 9 shows a flowchart illustrating steps of the method 300 for forming a housing element 100 using a semi-finished part 100, as described above and below, according to an embodiment. Method 300 preferably includes the same steps S1 through S3 as previously described with reference to FIG. 8. Further preferably, method 300 further includes the steps of placing S4 a cell element 302, orienting S5 cover element 22, and joining S6 cover element 22. Further preferably, method 300 further includes the steps of filling S7 the fluid-tight space, and sealing S8 the fluid-tight space. Further preferably, method 300 further includes the steps of cleaning and/or deburring S9 semi-finished part 10 prior to orienting S2 and/or the step of cleaning and/or deburring S10 semi-finished part 10 after joining S3.

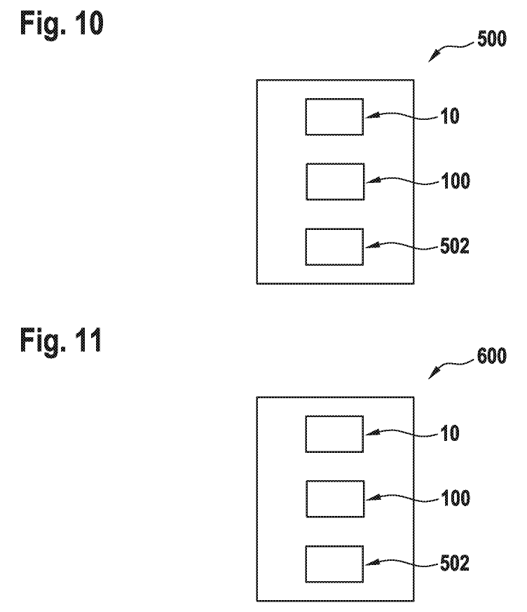

FIG. 10 shows a vehicle 500 according to an embodiment. Vehicle 500 preferably includes a semi-finished part 10, as described above and below, a housing element 100, as described above and below, and/or a housing element 100 that was formed using the method 300 for forming a housing element 100, as described above and below, and/or a component 502 that was produced using the method 400 for forming a semi-finished part 10, as described above and below.

FIG. 11 shows a stationary storage device 600 including a semi-finished part 10, as described above and below, a housing element 100, as described above and below, and/or which was produced using the method 300 for forming a housing element 100, as described above and below, and/or a component 502 that was produced using the method 400 for forming a semi-finished part 10, as described above and below.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A semi-finished part for forming a housing element of a cell unit, comprising:
a base element having a first side opposite a second side;
a first side element disposed contiguously with the base element at the first side;
a second side element disposed contiguously with the base element at the second side; and
a third side element disposed contiguously with the second side element at a side opposite the base element,
wherein the base element, the first side element, the second side element, and the third side element are disposed in a plane, and
wherein the base element, the first side element, the second side element, and the third side element are adapted to form a circumferentially closed, fluid-tight main body in which a cell element of the cell unit can be disposed.

2. The semi-finished part as recited in claim 1, further comprising a bottom element contiguous with the base element, wherein the base element, the first side element, the second side element, the third side element, and the bottom element are adapted to form the circumferentially closed, fluid-tight main body in which the cell element of the cell unit can be disposed.

3. The semi-finished part as recited in claim 2, further comprising a cover element which is disposed opposite the bottom element and contiguous with the base element, wherein the base element, the first side element, the second side element, the third side element, the bottom element, and the cover element are adapted to form the circumferentially closed, fluid-tight main body in which the cell element of the cell unit can be disposed.

4. The semi-finished part as recited in claim 3, wherein a bending line is provided between the base element and the first side element, between the base element and the second side element, between the second side element and the third side element, and/or between the base element and the bottom element, and/or between the base element and the cover element.

5. The semi-finished part as recited in claim 3, wherein a contacting element is disposed in the first side element, in the second side element, in the third side element, and/or in the base element, and/or in the bottom element, and/or in the cover element, the contacting element is adapted to conduct electrical energy from an inside of a substantially fluid-tight space to an outside of the housing element.

6. The semi-finished part as recited in claim 3, wherein the base element, the first side element, the second side element, the third side element, the bottom element, and/or the cover element have a filling opening for filling with an electrolyte and/or a rupture element adapted to enable a fluid to flow out of a substantially fluid-tight space when a predetermined temperature and/or a predetermined pressure in the housing element is exceeded.

7. A method for forming a housing element using a semi-finished part according to claim 1, comprising the steps of:
providing the semi-finished part, including the base element, the first side element, the second side element, and the third side element;
orienting the first side element, the second side element, and the third side element relative to the base element; and
joining the first side element to the third side element to form a hollow body with an open bottom and cover.

8. The method as recited in claim 7, wherein the semi-finished part further comprises a bottom element, which is oriented relative to the base element and is joined to the hollow body to produce a hollow body with a closed bottom.

9. The method as recited in claim 8, wherein the semi-finished part further comprises a cover element, which is oriented relative to the base element and is joined to the hollow body to produce a hollow body with a closed cover.

10. The method as recited in claim 7, wherein a cell element is placed on the base element prior to the orienting step.

11. The method as recited in claim 10, wherein the cell element is placed in the hollow body after the joining step.

12. The method according to claim 9, wherein the cover element is subsequently joined to the hollow body.
